(19) United States
(12) Patent Application Publication
(10) Pub. No.: US 2024/0236948 A1
(43) Pub. Date: Jul. 11, 2024

(54) METHODS, DEVICES, AND SYSTEMS FOR TRANSMITTING AND RECEIVING SIGNAL FOR PAGING MESSAGES

(71) Applicant: ZTE Corporation, Shenzhen (CN)

(72) Inventors: Xuan MA, Shenzhen (CN); Mengzhu CHEN, Shenzhen (CN); Jun XU, Shenzhen (CN); Focai PENG, Shenzhen (CN)

(73) Assignee: ZTE Corporation, Shenzhen (CN)

(21) Appl. No.: 18/616,746

(22) Filed: Mar. 26, 2024

Related U.S. Application Data
(63) Continuation of application No. PCT/CN2021/129033, filed on Nov. 5, 2021.

(51) Int. Cl. H04W 68/02; H04W 56/00; H04W 76/28

(52) U.S. Cl. CPC H04W 68/02; H04W 56/0015; H04W 76/28

(57) ABSTRACT

The present disclosure describes methods, system, and devices for transmitting and receiving signal for paging messages. One method includes include determining, by a user equipment (UE), a paging early indication occasion (PEI-O) based on at least one of the following: a reference location, a synchronization signal burst (SS burst) associated with the reference location, or an offset; and monitoring, by the UE, a paging early indication (PEI) in the PEI-O, wherein the PEI indicates information for at least one paging occasion (PO). Another method includes sending, by a base station to a user equipment (UE), a paging early indication (PEI) in a PEI occasion (PEI-O), wherein: the PEI-O is determined by at least one of the following: a reference location, an SS burst associated with the reference location, or an offset; and the PEI indicates information for at least one paging occasion (PO).

### TECHNICAL FIELD

The present disclosure is directed generally to wireless communications. Particularly, the present disclosure relates to methods, devices, and systems for transmitting and receiving signal for paging messages.

### BACKGROUND

Wireless communication technologies are moving the world toward an increasingly connected and networked society. High-speed and low-latency wireless communications rely on efficient network resource management and allocation among one or more user equipment and one or more wireless access network nodes (including but not limited to base stations). A new generation network is expected to provide high speed, low latency and ultra-reliable communication capabilities and fulfill the requirements from different industries and users.

With the rapid evolution of cellular mobile communication systems, for example in the present wireless telecommunication protocol, a user equipment (UE) may need to monitor a paging occasion (PO) in each paging cycle, so that the UE may obtain a paging message according to the paging occasion. However, under most circumstances, the UE may not have paging messages in all paging cycles, so that actively monitoring paging occasions may result in unnecessary power consumption. This issue/problem may be severe for some UEs with relatively low paging probability, which may receive a larger number of unnecessary paging messages, causing unnecessarily-high power consumption.

The present disclosure describes various embodiments for transmitting and receiving signal for paging messages, addressing at least one of the problems/issues discussed above. The various embodiments in the present disclosure may reduce and/or save power consumption, increase efficiency of monitoring paging occasions, and/or improve accuracy of receiving paging messages, thus improving user experience and/or a technology field in the wireless communication.

### SUMMARY

This document relates to methods, systems, and devices for wireless communication, and more specifically, for transmitting and receiving signal for paging messages.

In one embodiment, the present disclosure describes a method for wireless communication. The method may include determining, by a user equipment (UE), a paging early indication occasion (PEI-O) based on at least one of the following: a reference location, a synchronization signal burst (SS burst) associated with the reference location, or an offset; and monitoring, by the UE, a paging early indication (PEI) in the PEI-O, wherein the PEI indicates information for at least one paging occasion (PO).

In another embodiment, the present disclosure describes a method for wireless communication. The method includes sending, by a base station to a user equipment (UE), a paging early indication (PEI) in a PEI occasion (PEI-O), wherein: the PEI-O is determined by at least one of the following: a reference location, an SS burst associated with the reference location, or an offset; and the PEI indicates information for at least one paging occasion (PO).

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1 shows an example of a wireless communication system include one wireless network node and one or more user equipment.

FIG. 2 shows an example of a network node.

FIG. 3 shows an example of a user equipment.

FIG. 4A shows a flow diagram of a method for wireless communication.

FIG. 4B shows a flow diagram of a method for wireless communication.

FIG. 5A shows an example of an exemplary embodiment for wireless communication.

FIG. 5B shows an example of an exemplary embodiment for wireless communication.

FIG. 5C shows an example of an exemplary embodiment for wireless communication.

FIG. 6 shows an example of an exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes various methods and devices for transmitting and receiving signal for paging messages.

With the rapid evolution of cellular mobile communication systems, for example in the present wireless telecommunication protocol, a user equipment (UE) may need to monitor a paging occasion (PO) in each paging cycle, for example each discontinuous receiving (DRX) cycle, so that the UE may obtain a paging message according to the paging occasion. However, under most circumstances, the UE may not have paging messages in all paging cycles, so that actively monitoring paging occasions may result in unnecessary power consumption. This issue/problem may be severe for some UEs with relatively low paging probability, by which a larger number of unnecessary paging messages may be received, causing unnecessarily high power consumption.

In some implementations, a paging early indication (PEI) with indication information before the PO can indicate whether a UE needs to receive paging physical downlink control channel (PDCCH) in the PO. This may reduce the power consumption caused by paging reception. In some implementations, different PEI location may bring different power saving effects.

In some embodiments, different conditions or configurations may allow UEs to locate PEIs accurately and to reduce power consumption caused by blind detection.

The present disclosure describes various embodiments for transmitting and receiving signal for paging messages, addressing at least one of the problems/issues discussed above. The various embodiments in the present disclosure may reduce and/or save power consumption, increase efficiency of monitoring paging occasions, and/or improve accuracy of receiving paging messages, thus improving user experience and/or a technology field in the wireless communication.

In some implementations, a UE may monitor one paging occasion (PO) per discontinuous receiving (DRX) cycle (i.e., paging cycle). One Paging Frame (PF) is one Radio Frame and may contain one or more PO or starting point of a PO. The PF and PO for paging may determined by the following formulae. A system frame number (SFN) for the PF is determined by (SFN+PF_offset) mod T=(T div N)*(UE_ID mod N), and an index (i_s) indicating the index of the PO is determined by i_s=floor (UE_ID/N) mod Ns, wherein T denotes a DRX cycle of the UE; N denotes a number of total paging frames in T; Ns denotes a number of paging occasions for a PF; PF_offset denotes an offset used for PF determination; UE_ID denotes a 5th Generation (5G) system temporary mobile subscription identifier (5G-S-TMSI) mod 1024.

In some implementations, a value of N*Ns may determine a number of POs in a DRX cycle, that is a density of POs in the DRX cycle, wherein N is a number of total paging frames in a DRX cycle; and Ns is a number of paging occasions for a PF.

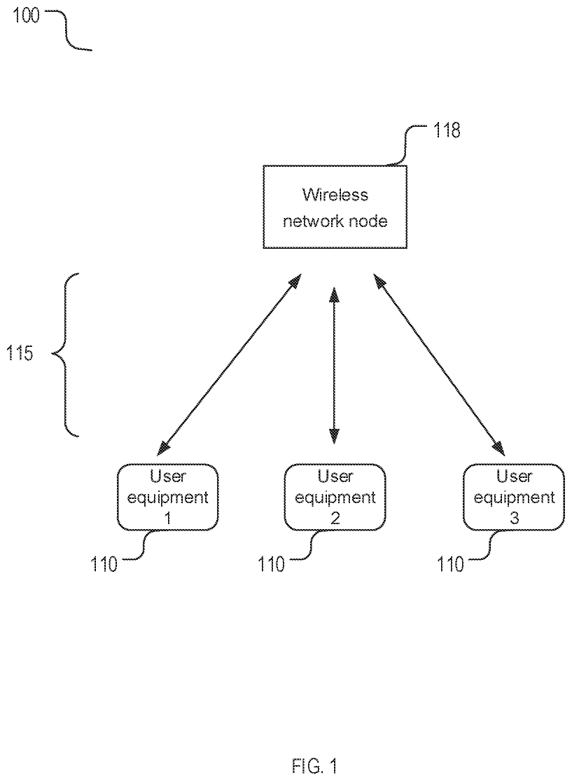

FIG. 1 shows a wireless communication system 100 including a wireless network node 118 and one or more user equipment (UE) 110. The wireless network node may include a network base station, which may be a nodeB (NB, e.g., a gNB, a eNB) in a mobile telecommunications context. Each of the UE may wirelessly communicate with the wireless network node via one or more radio channels 115. For example, a first UE 110 may wirelessly communicate with a wireless network node 118 via a channel including a plurality of radio channels during a certain period of time. The network base station 118 may send high layer signalling to the UE 110. The high layer signalling may include configuration information for communication between the UE and the base station. In one implementation, the high layer signalling may include a radio resource control (RRC) message.

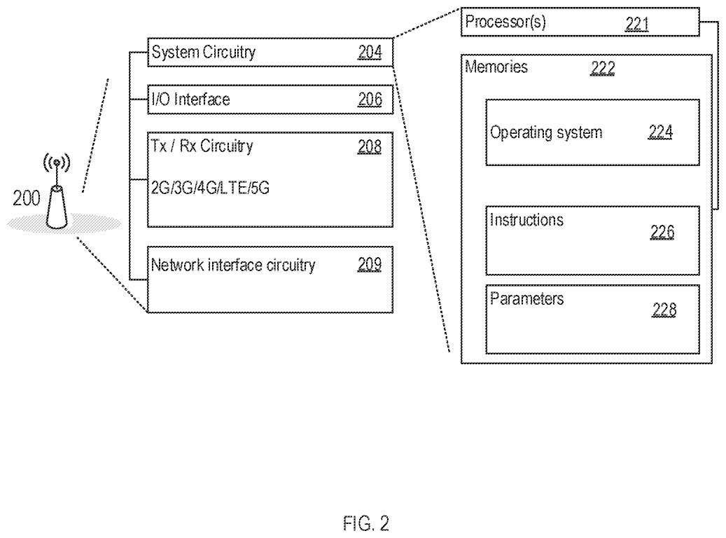

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the network node. The parameters 228 may include parameters to support execution of the instructions 226. For example, parameters may include network protocol settings, bandwidth parameters, radio frequency mapping assignments, and/or other parameters.

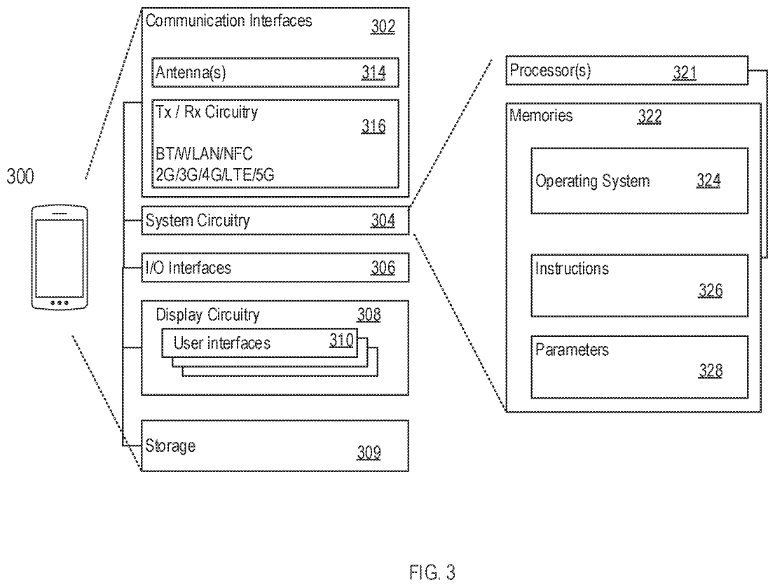

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G, and/or any future generation wireless communication standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

The present disclosure describes several below embodiments, which may be implemented, partly or totally, on the network base station and/or the user equipment described above in FIGS. 2-3.

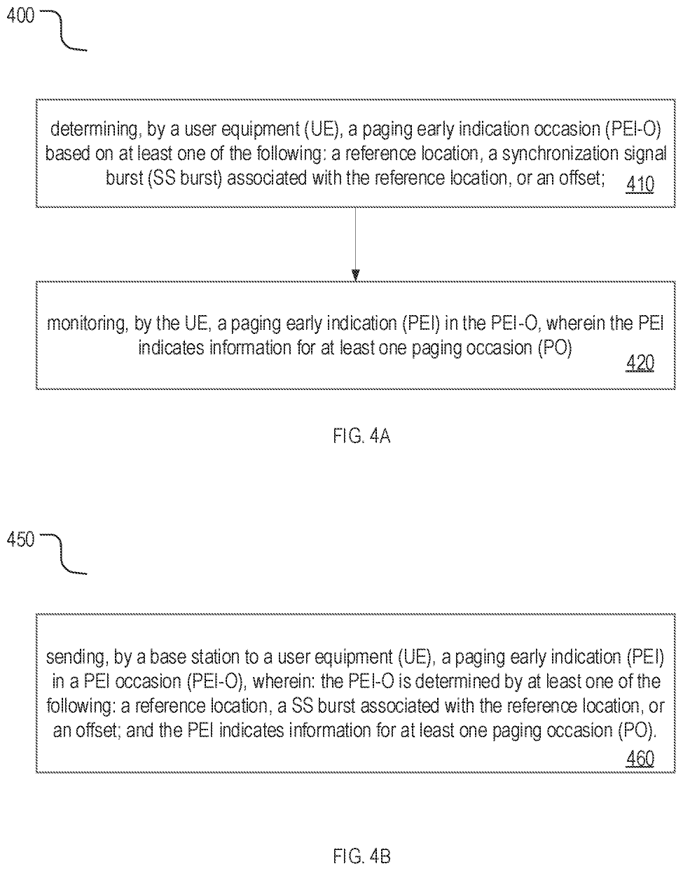

Referring to FIG. 4A, the present disclosure describes various embodiments of a method 400 for wireless communication. The method 400 may include a portion or all of the following steps: step 410, determining, by a user equipment (UE), a paging early indication occasion (PEI-O) based on at least one of the following: a reference location, a synchronization signal burst (SS burst) associated with the reference location, or an offset; and/or step 420: monitoring, by the UE, a paging early indication (PEI) in the PEI-O, wherein the PEI indicates information for at least one paging occasion (PO).

Referring to FIG. 4B, the present disclosure describes various embodiments of another method 450 for wireless communication. The method 450 may include step 460 sending, by a base station to a user equipment (UE), a paging early indication (PEI) in a PEI occasion (PEI-O), wherein: the PEI-O is determined by at least one of the following: a reference location, an SS burst associated with the reference location, or an offset; and the PEI indicates information for at least one paging occasion (PO).

In some implementation, an SS burst may include one or more synchronization signal block (SSB) occasions.

In some implementations, at least one of the following: the reference location, the SS burst associated with the reference location, or the offset, is determined by a condition, wherein the condition comprises at least one of the following: at least one PEI-O related configuration in a system information block (SIB); a number of POs associated with the PEI; a number of paging frames (PFs) associated with the PEI; a configuration of the offset; a search space of the PEI; a radio network temporary identifier (RNTI) of the PEI; a payload size of the PEI; a number of bits for a paging indication field of the PEI; a number of sub-groups in one PO indicated by the PEI; a sub-grouping method; a UE type of the UE; a UE capability of the UE; a coverage level; a type of discontinuous receiving (DRX); frequency range; or a sub-carrier spacing (SCS). In some example, PFs associated with the PEI may refer to PFs that include at least one paging occasion indicated by the PEI. In another example, PFs associated with the PEI may refer to PFs that include at least one paging occasion (PO) associated with the PEI. In some example, one PO associated with the PEI implies that the PEI indication paging information for the PO.

In some other implementations, the reference location is associated with at least one of the following: a paging occasion (PO), a paging occasion group, a radio frame (RF), a paging frame (PF), or the synchronization signal burst (SS burst).

In some other implementations, the offset comprises a first offset to determine the reference location, wherein the first offset comprises at least one of the following: an offset from the reference location to a PF of a target PO; an offset from the reference location to a PF of a target PO group; an offset from the reference location to the target PO; or an offset from the reference location to the target PO group.

In some other implementations, the offset comprises a second offset, wherein the second offset is an offset from the PEI-O to the SS burst related to the reference location.

In some other implementations, the offset comprises a third offset, wherein the third offset is an offset from the PEI-O to the reference location.

In some other implementations, the SS burst comprises at least one of the following: a L-th SS burst before a target PO; the L-th SS burst before a target PO group; the L-th SS burst before the reference location; or the L-th SS burst in a duration, wherein the duration comprises at least one of the following: a period from the reference location to a target PO, a period from the reference location to a target PO group, a period from the reference location to the PF of a target PO, or a period from the reference location to the PF of a target PO group; and L is a positive integer. In some implementation, L includes one or more values. In this example, the PEI-O can be configured in relative to one or more SS bursts. With this method, it allows flexible UE implementation.

In some other implementations, the condition comprises at least one PEI-O related configuration in an SIB; and when the information in SIB is transmitted: the PEI-O is determined by an SS burst associated with a reference location, wherein the reference location is determined by a first offset, or the PEI-O is determined by a second offset from the PEI-O to an SS burst, wherein the SS burst associated with the reference location, and the reference location is determined by a first offset.

In some other implementations, the condition comprises at least one PEI-O related configuration in an SIB, for example, a configuration of at least one of the first offset, the second offset, or the third offset. In some implementation, the PEI-O is determined by the reference location, and the SS burst related to the reference location. In some implementation, the start of PEI-O is determined by the reference location. In this implementation, the end of PEI-O is determined by the SS burst related to the reference location. For example, the start of the PEI-O is defined in relative to the reference location, e.g., after or no earlier than the reference location. For example, the end of the PEI-O is defined in relative to the SS burst related to the reference location, e.g., before or no later than the SS burst related to the reference location.

In some implementation, the end of PEI-O is determined by the reference location. In this implementation, the start of PEI-O is determined by the SS burst related to the reference location. For example, the end of the PEI-O is defined in relative to the reference location, e.g., before or no later than the reference location. For example, the start of the PEI-O is defined in relative to the SS burst related to the reference location, e.g., after or no earlier than the SS burst related to the reference location.

In some other implementations, the condition comprises a number of POs associated with the PEI; and when the PEI is configured to indicate one PO, the PEI-O is determined by one of the following: a third offset from the PEI-O to the reference location, wherein the reference location is a target PO, a L-th SS burst before the reference location, wherein the reference location is the target PO, or the L-th SS burst in a duration, wherein the duration is a period from the reference location to the target PO, and the reference location is determined by a first offset.

In some other implementations, the condition comprises a number of POs associated with the PEI and a number of paging frames (PFs) associated with the PEI; and when the PEI is configured to indicate one or more PO in one PF, the PEI-O is determined by one of the following: the reference location determined by a first offset, wherein the reference location is a RF; a L-th SS burst before the reference location, wherein the reference location is determined by a first offset; the L-th SS burst in a duration; or a third offset from the PEI-O to a reference location, wherein the reference location is the target PO.

In some other implementations, the condition comprises a number of POs associated with the PEI and a number of paging frames (PFs) associated with the PEI; and when one PEI is configured to indicate a plurality of POs in a plurality of PFs, the PEI-O is determined by one of the following: the reference location determined by a first offset, wherein the reference location is a RF; a L-th SS burst before the reference location, wherein the reference location is determined by a first offset; the L-th SS burst in a duration, wherein the duration is a period from the reference location to the target PO, and the reference location is determined by a first offset; the L-th SS burst before the reference location, wherein the reference location is a target PO; or a third offset from the PEI-O to the reference location, wherein the reference location is the target PO.

In some other implementations, the condition comprises a configuration of the offset; and when the offset is not configured, the PEI-O is determined by an SS burst associated with the reference location; and the reference location comprises at least one of the following: a target PO, a target PO group, a PF of the target PO, or the PF of the target PO group.

In some other implementations, the condition comprises a search space of the PEI; and when the search space is a paging search space, the PEI-O is determined by one of the following: the reference location determined by a first offset; or a third offset from the PEI to the reference location, wherein the reference location comprises at least one of the following: a target PO, a target PO group, a PF of the target PO, or the PF of the target PO group.

In some other implementations, the condition comprises a number of bits for a paging indication field of the PEI and a number of sub-groups in one PO indicated by the PEI; when the ratio of the number of bits for a paging indication field to the number of sub-groups in one PO is greater than a threshold, the PEI-O is determined by one of the following: the reference location determined by a first offset; a L-th SS burst before the reference location; the L-th SS burst in a duration, wherein the duration is a period from the reference location to the target PO, and the reference location is determined by a first offset; the L-th SS burst before the target PO; or a third offset from the PEI to the reference location, wherein the reference location is the target PO; and when the ratio of the number of bits for a paging indication field to the number of sub-groups in one PO is smaller than a threshold, the PEI-O is determined by one of the following: a third offset from the PEI to the reference location, wherein the reference location is the target PO; the L-th SS burst before the target PO; or the L-th SS burst in the duration.

In some other implementations, at least one of the first offset or the third offset comprises a list of offsets, each PO corresponds to one offset in the list of offsets, each PO group corresponds to one offset in the list of offsets, or each PF corresponds to one offset in the list of offsets.

In some implementation, at least one of the first offset, the second offset or the third offset comprises a list of offsets. In this implementation, each offset corresponds to a PEI-O. In this example, it allows multiple PEI transmission occasion and more flexibility for UE detection of PEI.

In some other implementations, at least one of the first offset, the second offset or the third offset comprises a list of offsets. In some implementation, the number of offsets in the list is determined by the number of POs or PFs associated with the PEI. In some implementation, each offset corresponds to a PO or PF associated with the PEI.

In some implementation, a set of candidate value of at least one of the first offset, the second offset or the third offset is determined by at least one of sub-carrier spacing, UE capability. In some example, the maximum value of the set of candidate value of at least one of the first offset, the second offset or the third offset is O*2\hat{ }(u) for sub-carrier spacing of 15 killoHz (KHz), 30 KHz, 60 KHz, 120 KHz, where u is 0, 1, 2, 3 for sub-carrier spacing of 15 KHz, 30 KHz, 60 KHz, 120 KHz, respectively, and O is a positive number.

In some other implementations, the first offset is in a unit of T/N RF, wherein T is a DRX cycle of the UE, N is a number of total paging frames in T; or the difference of the value in the list of the offsets is in the unit of T/N RF.

In some other implementations, a value of L is determined by at least one of the following: a high layer configuration; a high layer parameter; a pre-determined value; a value in a list comprising a range from 1 to a maximum value; or an SIB.

In some other implementations, the SS burst comprises an SS burst before the PO, wherein the SS burst before the PO refers to at least one of the following: a last SSB occasion of the SS burst before a first physical downlink control channel (PDCCH) monitoring occasion of the PO; a first SSB occasion of the SS burst before the first PDCCH monitoring occasion of the PO; the last SSB occasion of the SS burst before the first PDCCH monitoring occasion of a first PO in the PF related to the PEI; or the last SSB occasion of the SS burst before the start of the PF related to the PEI. In some implementations, a “last” SSB occasion of the SS burst may refer to an SSB occasion being the latest in time domain of the SS burst; a “first” physical downlink control channel (PDCCH) monitoring occasion of the PO may refer to a physical downlink control channel (PDCCH) monitoring occasion being the earliest in time domain of the PO; and/or a “first” SSB occasion of the SS burst may refer to an SSB occasion being the earliest in time domain of the SS burst.

In some implementations, the reference location is the start or end of the reference location.

In some other implementations, the UE does not expect the PEI to overlap with the SS burst in the time domain; or the UE does not expect the PEI to overlap with the target PO in the time domain.

In various embodiment, a UE may determine and/or monitor a paging early indication occasion (PEI-O) that is sent by a base station (e.g., gNB). The present disclosure describes below examples for various embodiments. These exemplary embodiments are intended for illustrative purpose only, as reflective and representative of many more broader embodiments, and are not intended to restrict the scope or applicability of the present disclosure.

### Monitoring PEI in PEI-O

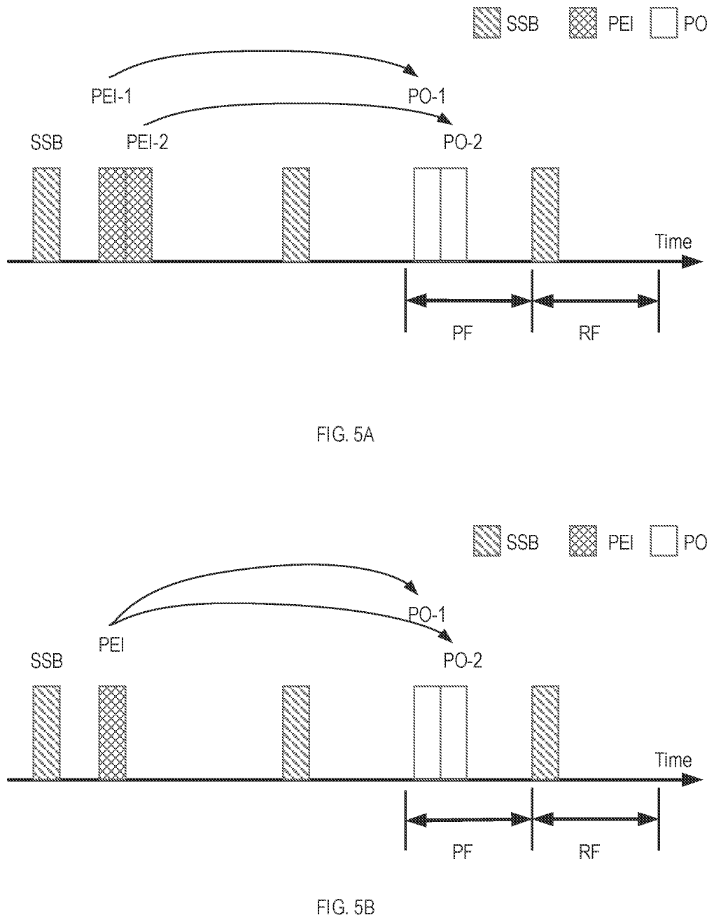

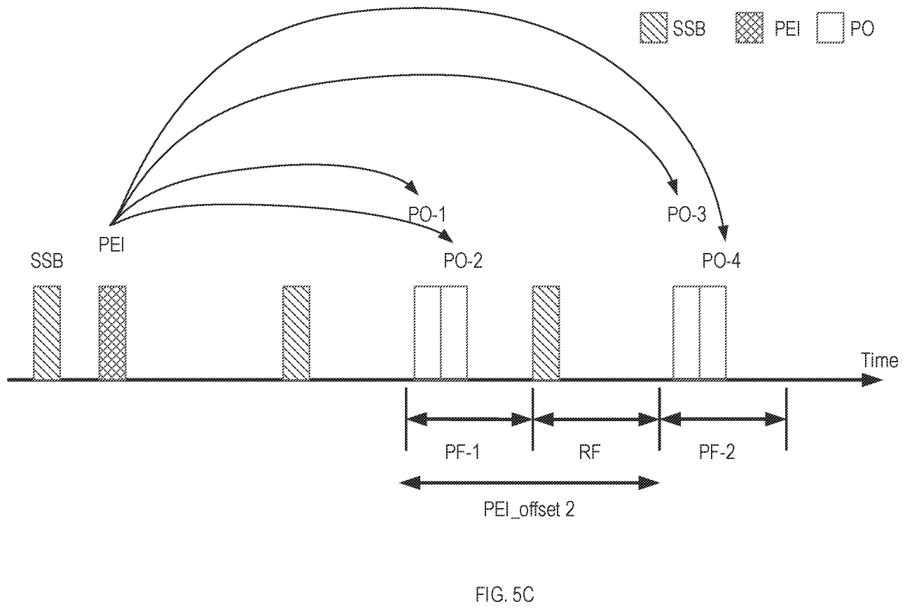

In some embodiments, a UE may monitor a PEI in a PEI occasion (PEI-O), wherein the PEI-O is a set of PEI monitoring occasions, as shown in FIGS. 5A, 5B, and 5C.

In some implementations, the PEI occasion (PEI-O) means that the first PDCCH monitoring occasion of the PEI-O. In some other implementations, the PEI-O means that the last PDCCH monitoring occasion of the PEI-O. In some other implementations, the PEI-O means that the PDCCH monitoring occasion of PEI-O with some specific characteristics, for example, the PDCCH monitoring occasion has a same QCL assumption as that of the PDCCH monitoring occasion for paging in the PO; or the PDCCH monitoring occasion has the same QCL assumption as that of the SS burst.

In some implementations, the SS burst may be a set of SSB occasion. In some embodiments, the PEI can be configured to indicate one PO.

Referring to FIG. 5A, an embodiment includes two PEIs indicating two POs: a first PEI (PEI-1) indicates a first PO (PO-1), and a second PEI (PEI-2) indicates a second PO (PO-2).

In some other some embodiments, a PEI may be configured to indicate more than one POs in one PF. The UE may correspond to a j-th PO in the PF and monitor an i-th PEI-O, where i=ceil (j/P), where a value of P is a number of POs indicated by one PEI. Here, “ceil( )” may refer to a ceiling function. The UE corresponds to the j-th PO means that the UE monitors the paging PDCCH and receives the paging message in the j-th PO.

Referring to FIG. 5B, an embodiment includes one PEI indicating two POs: a PEI indicates a first PO (PO-1) and a second PO (PO-2). The first PO (PO-1) and the second PO (PO-2) are in a same PF.

In some other embodiments, one PEI may be configured to indicate multiple POs in multiple PFs.

Referring to FIG. 5C, an embodiment includes one PEI indicating two POs in one PF and anther two POs in another PF: a PEI indicates a first PO (PO-1) and a second PO (PO-2) in a first PF (PF-1), and a third PO (PO-3) and a fourth PO (PO-4) in a second PF (PF-2). The first PF and the second PF are two different PFs.

### Related Parameters

In some embodiments, the PEI monitoring occasion (PEI-O) is determined by at least one of a reference location; a first offset to a target PO or the target PO group, wherein the target PO is the PO associated with the PEI, the target PO group comprises multiple POs associated with the same PEI; an SS burst before the target PO or the target PO group, wherein the SS burst is the L-th SS burst before the reference location, or the L-th SS burst before the target PO or the target PO group or the L-th SS burst in a duration, the period of the duration is determined by a first offset, at least one of the start or the end of the duration is determined by a reference location; a second offset from PEI to an SS burst, wherein the SS burst is the L-th SS burst before the reference location, or the L-th SS burst before the target PO or the target PO group or the L-th SS burst in the first offset; a third offset from a reference location to the PEI.

In some embodiments, a PO associated with the PEI means that the paging indication for the PO is carried in the PEI.

### Reference Location

In some embodiments, the reference location is associated with at least one of the following: a paging occasion (PO), a paging occasion group, a radio frame (RF), a paging frame (PF), or a synchronization signal burst (SS burst).

In some other embodiments, the reference location comprises at least one of the following: a target PO, a target PO group, a PF of the target PO, a PF of the target PO group, an SS burst, the start of a duration or the end of a duration.

In some other embodiments, the reference location is determined by an offset. In some other embodiments, the offset comprises at least one of the following: an offset from the reference location to a PF of a target PO; an offset from the reference location to a PF of a target PO group; an offset from the reference location to the target PO; or an offset from the reference location to the target PO group.

In some other embodiments, a reference location is a reference frame determined by a frame-level offset to the PF of the target PO or the target PO group.

In some other embodiments, the reference location is a start of the reference frame, for example, the reference location is the first slot of the reference frame.

In some other embodiments, the reference location is a reference point that determined by a millisecond (ms) or a slot-level offset to the target PO or the target PO group.

In some other embodiments, there is no SS burst between the reference location and the target PO. In some other embodiments, there is no SS burst between the reference location and the first PO of the target PO group.

### First Offset

In some embodiments, a first offset may be a PEI_offset, which is an offset to a PF of a target PO or a target PO group. In some other embodiments, the offset is a frame-level offset.

In some other embodiments, the offset to the PF of the target PO group comprises at least one of an offset to the PF of the first PO in the target PO group, a list of offset that each offset corresponds to a PF of one PO, a list of offset that each offset corresponds to one PF of the POs belong to the same PF, a list of offset that each offset corresponds to a PF of one PO in the target PO group or a list of offset that each offset corresponds to one PF of the POs belong to the same PF in the target PO group. In some embodiments, the first PO of the target PO group is the earliest PO of the POs indicated by one PEI. In some other embodiments, the first PO of the target PO group is the earliest PO in one PF.

In some other embodiments, the PEI_offset may be a list of offset, each PF corresponds to a PEI_offset. The PEI_offset corresponding to different PF can be different. In some other embodiments, each PF corresponds to a PEI_offset. The PEI_offset corresponds to different PF may be the same. In some other embodiments, only one PEI_offset may be configured, and/or the PEI_offset may be a cell specific parameter.

In some other embodiments, the PEI_offset is a list of offset, each PO corresponds to a PEI_offset. In some embodiments, the PEI_offset for different POs in one PF is different. In some other embodiments, the PEI_offset for different POs in one PF is the same.

In some other embodiments, the PEI_offset may be larger than 0 or equal to 0. In some implementations, the PEI_offset being zero may indicate that the reference frame is the frame that the target PO belongs to. In some other implementations, the PEI_offset being zero may indicate that the reference frame is the frame that the first PO in the target PO group belongs to.

In some other embodiments, the PEI_offset with a unit of T/N radio frame, where T is a DRX cycle of the UE, N is a number of total paging frames in T. In some other implementations, the PEI_offset with a unit of radio frames (RFs). In some other implementations, the difference of the value in the offset list may be in the unit of T/N.

In some other embodiments, only one PEI_offset may be configured. When POs in multiple PFs are indicated by one PEI, the offset of the POs in i-th PF is PEI_offset+(i−1)×(T/N).

In some other embodiments, the first offset is a PEI_offset, which is an offset to the target PO or the target PO group. In some other embodiments, the offset is a slot/ms level offset. In some embodiments, the offset to the target PO group comprise at least one of an offset to the first PO in the target PO group, a list of offsets where each offset corresponds to the first PO in the target POs in one PF, a list of offsets where each offset corresponds to one PO in the target PO group. In some embodiments, the first PO of the target PO group is the earliest PO of the POs indicated by one PEI.

In some other embodiments, the first offset is a PEI_offset, which is a ms or slot-level offset to the PF of the target PO belongs to.

In some other embodiments, the PEI_offset may be a list of offset, Each PO corresponds to a PEI_offset. The PEI_offset corresponding to different PO may be different. In some other implementations, each PF corresponds to a PEI_offset. The PEI_offset corresponding to different PF may be different.

### SS Burst

In some embodiments, an SS burst may be an SS burst before a target PO or a target PO group. In some other embodiments, the SS burst is the L-th SS burst before the reference location. In some other embodiments, the SS burst is the L-th SS burst in a duration, wherein the period of the duration is determined by a first offset, at least one of the start or the end of the duration is determined by a reference location. L is a integer.

In some other embodiments, a value of L may be determined by at least one of the following: a high layer configuration, for example, the value of the L is configured by a high layer parameter in the high layer configuration; a pre-determined value, L>0; a value in a list, for example, a range of the value in the list is 1-Lₘₐₓ wherein Lₘₐₓ is a maximum value for L; or a broadcast message, for example an SIB.

In some other embodiments, the value of L for different PO indicated by a same PEI may be different when one or more SS bursts exists between different POs indicated by the same PEI.

### Second Offset

In some embodiments, a second offset may be a slot/ms level offset to an SS burst. In some implementations, the SS burst may be a L-th SS burst before the reference location, or the L-th SS burst before the target PO or the target PO group or the L-th SS burst in the first offset. In some other implementations, the second offset is determined by at least one of the following: a high layer configuration, a number of transmitted SSB, a subcarrier spacing (SCS), or a pre-set value.

In some other embodiments, the second offset is an offset between a first PDCCH monitoring occasion of the PEI-O to a first occasion of the SS burst. In some implementations, the second offset is the offset between the first PDCCH monitoring occasion of the PEI-O to the last occasion of the SS burst. Here, the “last” occasion of the SS burst may refer to the latest occasion in a time domain of the SS burst. In some other implementations, the second offset is the offset between the last PDCCH monitoring occasion of the PEI-O to the first occasion of the SS burst. Here, the “first” occasion of the SS burst may refer to the earliest occasion in a time domain of the SS burst. In some other implementations, the second offset is the offset between the last PDCCH monitoring occasion of the PEI-O to the last occasion of the SS burst.

In some other embodiments, the offset may only have one value.

In some other embodiments, the multiple PEI may be associated with a same SS burst.

In some other embodiments, a PEI-O of an i-th (i≥1) PEI associated with the SS burst may be determined by an offset and a PEI duration that the PEI transmitted. For example, the PEI-O is a set of (S) consecutive PDCCH monitoring occasions which occupancy duration (D), the offset is the duration between the SS burst and the first PEI, then the i-th PEI associated with the SS burst may be determined by offset+(i−1)×D.

In some other embodiments, the PEI-O of the i-th (i≥1) PEI associated with the SS burst may be determined by the offset, the PEI duration that the PEI transmitted, and a pre-determined value (delta). The pre-determined value (delta) may be a duration between two PEI burst (PEI-O). For example, the PEI occasion (PEI-O) is a set of (S) consecutive PDCCH monitoring occasions which occupancy duration (D), the offset is a duration between the SS burst and the first PEI, then a first PDCCH monitor occasion of the i-th PEI associated with the L-th SS burst may be determined by offset+(i−1)×D+(i−1)×delta.

In some other embodiments, the offset may be a list of offsets.

In some other embodiments, multiple PEIs may be associated with a same SS burst. Each PEI corresponds to one value in the list of offsets. For example, the PEI-O of the i-th (i≥1) PEI associated with the SS burst may be determined by the i-th offset in the offset list.

Some other embodiments may be a combination of more than two embodiments/implementations/methods or a combination of any portions from more than two embodiments/implementations/methods.

### Third Offset

In some embodiments, the third offset is an offset from PEI to a reference location. In some other embodiments, the reference location is associated with at least one of the following: a PO, a PO group, a RF, a PF, or an SS burst.

### Embodiments Including Combined Schemes

In some implementations, a PEI_O may be determined by a second offset to a L-th SS burst before a reference location. The reference location may be a reference frame determined by a frame-level offset to the PF of the target PO or the target PO group.

In some other embodiments, the PEI-O is determined by an SS burst associated with a reference location, wherein the reference location is determined by a first offset.

In some other implementations, the PEI-O may be determined by a reference frame determined by a L-th SS burst before the target PO or the target PO group.

In some other embodiments, the PEI_O is determined by a third offset from PEI to a reference location. In some embodiments, the reference location comprises at least one of a PO, a PO group, a RF, a PF, or an SS burst. For example, the PEI-O is determined by an offset from PEI to a PO.

In some other embodiments, the PEI-O is determined by a reference location. In some other embodiments, the reference location is associated with at least one of a PO, a PO group, a RF, a PF, or an SS burst. In some other embodiments, the reference location is determined by an offset. For example, the reference location is a RF determined by an offset to a PF of the PO or the PO group.

In some other embodiments, the PEI-O is determined by an SS burst before a reference location. In some embodiments, the PEI-O is determined by the L-th SS burst before the target PO. In some other embodiments, the PEI-O is determined by the L-th SS burst before the target PO group.

In some other embodiments, the PEI-O is determined by a third offset from PEI to a reference location. For example, the PEI-O is determined by an offset from PEI to the target PO or the target PO group.

### More Embodiments Including Combined Schemes

In some implementations, the PEI-O is determined by a second offset to an SS burst before a reference location. In some implementations, a PEI_O may be determined by a second offset to a L-th SS burst before the target PO or the target PO group.

In some other implementations, the PEI_O may be determined by a second offset to the N-th SS burst in a duration from a reference location to the target PO or the target PO group. In some implementations, N may be a positive integer, i.e., N≥1.

In some other implementations, each PO may correspond to a first offset. In some other implementations, starts of different offsets corresponding to the POs indicated by a same PEI may be the same. In some embodiments, the offset corresponds to the first PO of multiple POs indicated by the same PEI is less than or equal to L times a cycle of SS burst.

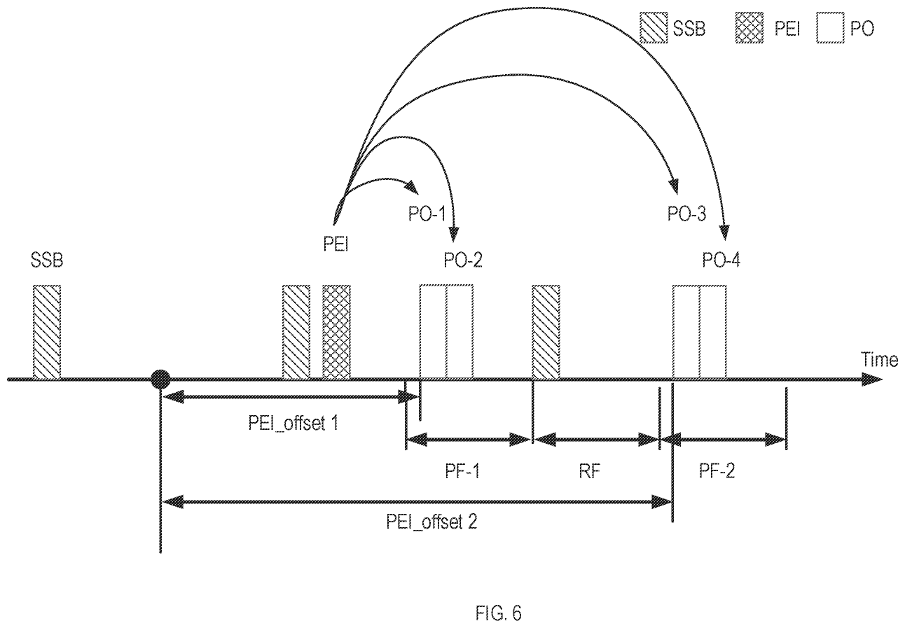

Referring to FIG. 6, an embodiment includes one PEI indicating two POs in one PF and anther two POs in another PF: a PEI indicates a first PO (PO-1) and a second PO (PO-2) in a first PF (PF-1), and a third PO (PO-3) and a fourth PO (PO-4) in a second PF (PF-2). The first PF and the second PF are two different PFs. The reference location may be indicated by the black dot, a first offset from the reference location to the PO-1 is a PEI_offset 1, and a second offset from the reference location to the PO-3 is a PEI_offset 2.

### Conditions for Determining PEI-O in Various Embodiments

In some embodiments, when an SIB with at least one PEI-O related configuration is transmitted, the PEI-O is determined by an SS burst associated with a reference location, wherein the reference location is determined by a first offset. In some other embodiments, when an SIB with at least one PEI-O related configuration is transmitted, the PEI-O is determined by a second offset from the PEI-O to an SS burst, wherein the SS burst associated with the reference location, and the reference location is determined by a first offset.

In various embodiments, a location of a PEI-O may be related to a number of POs or a number of PFs that a target PO belongs to.

In some embodiments, the PEI-O location may be determined by an offset to a target PO when one PEI configured to indicate one PO. In some implementations, the offset may be defined as a first PEI monitoring occasion to the first MO of the target PO; or the offset is defined as the first PEI monitoring occasion to the start of the PF for the target PO.

In some other implementations, the offset may be determined by at least one of the following: a high layer configuration; a cycle of SS burst; a number of SS bursts before the PO; a value configured by a high layer signaling, for example, the offset is equal to 10 millisecond (ms), 50 ms, etc.; being equal to L times an SS burst cycle; being equal to L times the cycle of SS burst plus a pre-determined value (delta), wherein offset=L×P_SSB+delta, delta≥0, L is a number of SS bursts before the PO (e.g., L is equal to 1, 2, 3, 4, or 5), and P_SSB is the cycle of the SS burst.

In some other embodiments, the PEI-O location may be determined by the L-th SS burst before the target PO when one PEI configured to indicate one PO.

In some other embodiments, when one PEI configured to indicate one PO, the PEI-O is determined by the L-th SS burst in a duration, wherein the duration is a period from the reference location to the target PO, and the reference location is determined by a first offset.

In some other embodiments, the PEI-O location may be determined by a reference frame determined by a frame-level offset to the PF of the target PO or PO group when one PEI configured to indicate one or multiple POs in one PF.

In some other embodiments, the PEI-O location may be determined by a second offset to the L-th SS burst before the reference location when one PEI configured to indicate one or multiple POs in one PF, wherein the reference location is the reference frame determined by a frame-level offset to the PF of the target PO or the target PO group.

In some other embodiments, the PEI-O location may be determined by an offset to a target PO when one PEI configured to indicate multiple POs in multiple PFs.

In some other embodiments, the PEI-O location may be determined by the L-th SS burst before the target PO when one PEI configured to indicate multiple POs in multiple PFs.

In some other embodiments, the PEI-O location may be determined by a reference frame determined by a frame-level offset to the PF of the target PO or PO group when one PEI configured to indicate multiple POs in multiple PFs.

In some other embodiments, the PEI-O location may be determined by a second offset to the L-th SS burst before the reference location when one PEI configured to indicate multiple POs in multiple PFs, wherein the reference location is the reference frame determined by a frame-level offset to the PF of the target PO or the target PO group.

In some other embodiments, the location of PEI-O may be related to at least one of a first offset, a value related to an SS burst, for example the L-th SS burst before the target PO or PO group, or a N-th SS burst within an offset. In some implementations, the PEI-O location may be determined by the L-th SS burst before the target PO when the first offset is not configured. In some other implementations, the PEI-O may be determined by an offset to the target PO or the target PO group when the value related to an SS burst is not configured. In some other implementations, the PEI-O may be determined by an offset to the PF of the target PO or the target PO group when the value related to the SS burst is not configured.

In some other embodiments, the location of PEI-O may be related to a search space of the PEI. In some implementations, the PEI-O may be determined by an offset to the target PO or the target PO group when a search space (e.g., pagingSearchSpace) is configured to the PEI. In some other implementations, the PEI-O may be determined by an offset to the PF of the target PO or the target PO group when the pagingSearchSpace is configured to the PEI.

In some other embodiments, the location of PEI-O may be related to a RNTI of the PEI. In some implementations, the PEI-O may be determined by an offset to the target PO or the target PO group when the P-RNTI is configured to the PEI. In some other implementations, the PEI-O is determined by an offset to the PF of the target PO or the target PO group when the P-RNTI is configured to the PEI.

In some other embodiments, when the offset is not configured, the PEI-O is determined by an SS burst associated with the reference location; and the reference location comprises at least one of the following: a target PO, a target PO group, a PF of the target PO, or the PF of the target PO group.

In some other embodiments, the location of PEI-O may be related to a payload size of the PEI. For example, when the payload size of the PEI is greater than a threshold, the PEI-O is determined by at least one of the reference location determined by a first offset, for example, a RF determined by an offset to a PF of the target PO or target PO group; a L-th SS burst before the reference location, wherein the reference location is determined by an offset to a target PO or PO group or PF of the target PO or PF of the target PO group; the L-th SS burst in a duration; the L-th SS burst before the target PO or the target PO group; or a third offset from the PEI to the reference location, wherein the reference location is the target PO or target PO group. For another example, when the payload size of the PEI is less than a threshold, the PEI-O is determined by one of the following a third offset from the PEI to the reference location, wherein the reference location is the target PO or the target PO group; the L-th SS burst before the target PO; or the L-th SS burst in a duration.

In some other embodiments, the location of PEI-O may be related to a number of bits for paging indication field. In some other embodiments, the location of PEI-O may be related to a number of sub-groups in one PO. For example, when the ratio of the number of bits for a paging indication field to the number of sub-groups in one PO is greater than a threshold, the PEI-O is determined by at least one of the reference location determined by a first offset, for example, a RF determined by an offset to a PF of the target PO or target PO group; a L-th SS burst before the reference location, wherein the reference location is determined by an offset to a target PO or PO group or PF of the target PO or PF of the target PO group; the L-th SS burst in a duration; the L-th SS burst before the target PO or the target PO group; or a third offset from the PEI to the reference location, wherein the reference location is the target PO or target PO group. For another example, when the ratio of the number of bits for a paging indication field to the number of sub-groups in one PO is smaller than a threshold, the PEI-O is determined by one of the following: a third offset from the PEI to the reference location, wherein the reference location is the target PO; the L-th SS burst before the target PO; or the L-th SS burst in the duration.

In some other embodiments, the location of PEI-O may be related to a sub-grouping method. In some embodiments, when the sub-grouping method is related to the UE_ID, the PEI-O is determined by a frame-level offset from a reference location to the PF of the target PO or the target PO group.

In some other embodiments, the location of PEI-O may be related to a UE type or the UE capability.

In some other embodiments, the location of PEI-O may be related to the type of DRX.

In some other embodiments, the location of PEI-O may be related to the frequency range (FR). For example, when the UE is in FR 1, the PEI-O is determined by an SS burst before the reference location, wherein the reference location is determined by an offset to a target PO, or target PO group, or PF of the target PO, or the PF of the target PO group. For another example, the PEI-O is determined by an SS burst before the reference location, wherein the reference location comprises at least one of a PO, a PO group, a PF of the PO, or the PF of the PO group. In some other embodiments, when the UE is in FR 1, the PEI-O is determined by an offset to a target PO or target PO group.

In some other embodiments, the location of PEI-O may be related to a SCS. For example, when the value of the SCS smaller than a threshold, the offset used to determine a PEI-O is the slot level. When the value of the SCS greater than a threshold, the offset used to determine a PEI-O is the ms level.

In some embodiments, the determination of PEI-O is related to an SS burst. In some embodiments, the location of PEI-O is determined by a second offset to the SS burst.

Solutions for SS Burst Overlapping with Target PO in Time Domain

In some embodiments, an SS burst may comprise multiple SSB occasions, and the SS burst before the target PO refers to at least one of the following: the SS burst that the last SSB occasion of the SS burst is before the first PDCCH monitoring occasion of the target PO; the SS burst that the first SSB occasion of the SS burst is before the first PDCCH monitoring occasion of the target PO; the SS burst that the last SSB occasion of the SS burst is before the first PDCCH monitoring occasion of the first PO in the PF which target PO belongs to; or the SS burst that the last SSB occasion of the SS burst is before the start of the PF which target PO belongs to. Here, the “first” SSB occasion of the SS burst may refer to the “earliest” SSB occasion of the SSB burst in time domain; and/or the “last” SSB occasion of the SS burst may refer to the “latest” SSB occasion of the SSB burst in time domain.

In some other embodiments, the SS burst before the target PO group refers to at least one of the SS burst before the first PO in the PO group.

In some other embodiments, a UE does not expect the PEI to overlap with the SS burst in the time domain, and/or the UE may not receive the PEI to overlap with the SS burst in the time domain.

In some other embodiments, UE does not expect the PEI to overlap with the target PO in the time domain, and/or the UE may not receive the PEI to overlap with the target PO in the time domain.

In some other embodiments, the L-th SS burst before the target PO should meet the requirement that there should be enough time to process the PEI between the L-th SS burst and the target PO. In some implementations, a UE may not monitor the PEI if the PEI overlap with the target PO in the time domain, and the UE monitors the paging PDCCH. In some other implementations, a UE may monitor the PEI associate with the (L+1)-th SS burst.

The present disclosure describes methods, apparatus, and computer-readable medium for wireless communication. The present disclosure addressed the issues with transmitting and receiving signal for paging messages. The methods, devices, and computer-readable medium described in the present disclosure may facilitate the performance of wireless communication by transmitting and receiving signal for paging messages, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
determining, by a user equipment (UE), a paging early indication occasion (PEI-O) based on at least one of the following: a reference location, a synchronization signal burst (SS burst) associated with the reference location, or an offset; and
monitoring, by the UE, a paging early indication (PEI) in the PEI-O, wherein the PEI indicates information for at least one paging occasion (PO).

2. (canceled)

3. The method according to claim 1, wherein:
at least one of the following: the reference location, the SS burst associated with the reference location, or the offset, is determined by a condition, wherein the condition comprises at least one of the following:
at least one PEI-O related configuration in a system information block (SIB);
a number of POs associated with the PEI;
a number of paging frames (PFs) associated with the PEI;
a configuration of the offset;
a search space of the PEI;
a radio network temporary identifier (RNTI) of the PEI;
a payload size of the PEI;
a number of bits for a paging indication field of the PEI;
a number of sub-groups in one PO indicated by the PEI;
a sub-grouping method;
a UE type of the UE;
a UE capability of the UE;
a coverage level;
a type of discontinuous receiving (DRX);
a frequency range; or
a sub-carrier spacing (SCS).

4. The method according to claim 1, wherein the reference location is associated with at least one of the following: a paging occasion (PO), a paging occasion group, a radio frame (RF), a paging frame (PF), or a SS burst.

5. The method according to claim 1, wherein:
the offset comprises a first offset to determine the reference location, wherein the first offset comprises at least one of the following:
an offset from the reference location to a PF of a target PO;
an offset from the reference location to a PF of a target PO group;
an offset from the reference location to the target PO; or
an offset from the reference location to the target PO group;
the offset comprises a second offset, wherein the second offset is an offset from the PEI-O to the SS burst related to the reference location; or
the offset comprises a third offset, wherein the third offset is an offset from the PEI-O to the reference location.

6. (canceled)

7. The method according to claim 1, wherein:
the offset comprises a third offset, wherein the third offset is an offset from the PEI-O to the reference location.

8. (canceled)

9. (canceled)

10. (canceled)

11. The method according to claim 3, wherein:
the condition comprises a number of POs associated with the PEI and a number of paging frames (PFs) associated with the PEI; and
when the PEI is configured to indicate one or more PO in one PF, the PEI-O is determined by one of the following:
the reference location determined by a first offset, wherein the reference location is a RF;
a L-th SS burst before the reference location, wherein the reference location is determined by a first offset;
the L-th SS burst in a duration; or
a third offset from the PEI-O to a reference location, wherein the reference location is the target PO.

12. The method according to claim 3, wherein:
the condition comprises a number of POs associated with the PEI and a number of paging frames (PFs) associated with the PEI; and
when one PEI is configured to indicate a plurality of POs in a plurality of PFs, the PEI-O is determined by one of the following:
the reference location determined by a first offset, wherein the reference location is a RF;
a L-th SS burst before the reference location, wherein the reference location is determined by a first offset;
the L-th SS burst in a duration, wherein the duration is a period from the reference location to the target PO, and the reference location is determined by a first offset;
the L-th SS burst before the reference location, wherein the reference location is a target PO; or
a third offset from the PEI-O to the reference location, wherein the reference location is the target PO.

13-16. (canceled)

17. The method according to claim 5, wherein:
at least one of the first offset or the third offset comprises a list of offsets,
each PO corresponds to one offset in the list of offsets,
each PO group corresponds to one offset in the list of offsets, or
each PF corresponds to one offset in the list of offsets.

18. (canceled)

19. (canceled)

20. (canceled)

21. The method according to claim 1, wherein:
the UE does not expect the PEI to overlap with the SS burst in the time domain; or
the UE does not expect the PEI to overlap with the target PO in the time domain.

22. (canceled)

23. (canceled)

24. A method for wireless communication, comprising.
sending, by a base station to a user equipment (UE), a paging early indication (PEI) in a PEI occasion (PEI-O), wherein:
the PEI-O is determined by at least one of the following: a reference location, a synchronization signal burst (SS burst) associated with the reference location, or an offset; and
the PEI indicates information for at least one paging occasion (PO).

25. The method according to claim 24, wherein:
at least one of the following: the reference location, the SS burst associated with the reference location, or the offset, is determined by a condition, wherein the condition comprises at least one of the following:
at least one PEI-O related configuration in a system information block (SIB);
a number of POs associated with the PEI;
a number of paging frames (PFs) associated with the PEI;
a configuration of the offset;
a search space of the PEI;
a radio network temporary identifier (RNTI) of the PEI;
a payload size of the PEI;
a number of bits for a paging indication field of the PEI;
a number of sub-groups in one PO indicated by the PEI;
a sub-grouping method;
a UE type of the UE;
a UE capability of the UE;
a coverage level;
a type of discontinuous receiving (DRX);
a frequency range; or
a sub-carrier spacing (SCS).

26. The method according to claim 24, wherein the reference location is associated with at least one of the following: a paging occasion (PO), a paging occasion group, a radio frame (RF), a paging frame (PF), or a SS burst.

27. The method according to claim 24, wherein:
the offset comprises a first offset to determine the reference location, wherein the first offset comprises at least one of the following:
an offset from the reference location to a PF of a target PO;
an offset from the reference location to a PF of a target PO group;
an offset from the reference location to the target PO; or
an offset from the reference location to the target PO group;
the offset comprises a second offset, wherein the second offset is an offset from the PEI-O to the SS burst related to the reference location; or
the offset comprises a third offset, wherein the third offset is an offset from the PEI-O to the reference location.

28. The method according to claim 24, wherein:
the offset comprises a third offset, wherein the third offset is an offset from the PEI-O to the reference location.

29. The method according to claim 27, wherein:
at least one of the first offset or the third offset comprises a list of offsets,
each PO corresponds to one offset in the list of offsets,
each PO group corresponds to one offset in the list of offsets, or
each PF corresponds to one offset in the list of offsets.

30. The method according to claim 24, wherein:
the UE does not expect the PEI to overlap with the SS burst in the time domain; or
the UE does not expect the PEI to overlap with the target PO in the time domain.

31. An apparatus comprising:
a memory storing instructions; and
a processor in communication with the memory, wherein, when the processor executes the instructions, the processor is configured to cause the apparatus to perform:
determining a paging early indication occasion (PEI-O) based on at least one of the following: a reference location, a synchronization signal burst (SS burst) associated with the reference location, or an offset; and
monitoring a paging early indication (PEI) in the PEI-O, wherein the PEI indicates information for at least one paging occasion (PO).

32. The apparatus according to claim 31, wherein:
the offset comprises a first offset to determine the reference location, wherein the first offset comprises at least one of the following:
an offset from the reference location to a PF of a target PO;
an offset from the reference location to a PF of a target PO group;
an offset from the reference location to the target PO; or
an offset from the reference location to the target PO group;
the offset comprises a second offset, wherein the second offset is an offset from the PEI-O to the SS burst related to the reference location; or
the offset comprises a third offset, wherein the third offset is an offset from the PEI-O to the reference location.

33. A wireless communication node comprising:
a memory storing instructions; and
a processor in communication with the memory, wherein, when the processor executes the instructions, the processor is configured to cause the wireless communication node to perform:
sending, to a user equipment (UE), a paging early indication (PEI) in a PEI occasion (PEI-O), wherein:
the PEI-O is determined by at least one of the following: a reference location, a synchronization signal burst (SS burst) associated with the reference location, or an offset; and
the PEI indicates information for at least one paging occasion (PO).

34. The wireless communication node according to claim 33, wherein:
the offset comprises a first offset to determine the reference location, wherein the first offset comprises at least one of the following:
an offset from the reference location to a PF of a target PO;
an offset from the reference location to a PF of a target PO group;
an offset from the reference location to the target PO; or
an offset from the reference location to the target PO group;
the offset comprises a second offset, wherein the second offset is an offset from the PEI-O to the SS burst related to the reference location; or
the offset comprises a third offset, wherein the third offset is an offset from the PEI-O to the reference location.
